(19) United States
(12) Patent Application Publication
(10) Pub. No.: US 2022/0067595 A1
(43) Pub. Date: Mar. 3, 2022

(54) Method and System for Updating On-Line Reservations

(71) Applicant: Affirm, Inc., San Francisco, CA (US)

(72) Inventor: Qi (Nick) Zhu, San Francisco, CA (US)

(21) Appl. No.: 17/459,463

(22) Filed: Aug. 27, 2021

Related U.S. Application Data
(60) Provisional application No. 63/071,636, filed on Aug. 28, 2020.

(51) Int. Cl. G06Q 10/02; G06Q 50/12

(52) U.S. Cl. CPC G06Q 10/02; G06Q 50/12

(57) ABSTRACT

A method for updating online reservations may include receiving a request for a listing of available hotel rooms, retrieving available hotel room information from multiple servers, displaying the list of available hotel rooms, and receiving user selection of one of the available hotel rooms. The method may further include generating a reservation based on the user selection, monitoring hotel room prices, canceling an original reservation in response to identifying a lower price, generating a new reservation, and crediting a user account based on a price difference between the original reservation and the new reservation.

### FIELD OF THE INVENTION

The disclosure is directed generally electronic commerce, and more specifically, at a method and system for updating on-line reservations.

### BACKGROUND OF THE DISCLOSURE

Electronic commerce (e-commerce) has been a growing field for many years. This has extended to many different business areas including the purchase of merchandise, the purchase of sporting tickets and vacation bookings.

With vacation bookings, vacationers generally plan their travel months in advance so that they are able to reserve plane tickets and/or hotel rooms. Between the time the vacation books the hotel room and the travel date, the price of the hotel room may fluctuate both rising or lowering in price. Unless the vacationer is continuously monitoring hotel, or hotel room, prices, they may miss out on booking their hotel for a price that is lower than they originally paid.

Therefore, there is provided a method and system for updating on-line reservations.

### SUMMARY OF THE DISCLOSURE

A system and method of updating online, or on-line, reservations is disclosed. The system and method of the disclosure is preferably used for reservations where there is free cancellation, however, cancellation fees may also be applied. After making the reservation, such as a hotel, or hotel room, reservation, based on search criteria, the system can continuously monitor the price of hotels, or hotel rooms, based on the search criteria up until the travel date. In one embodiment, the system may only monitor prices of hotel rooms at the hotel that the original reservation was made at. In some embodiments, the system confirms that the new lower price includes the same hotel room characteristics, such as, but not limited to, amenities, features and hotel specials, as the original reservation such that the user is getting a better price for the same original reservation.

The system can then provide a credit to the user into a user account such that the user can then use this credit for future reservations or purchases. In another embodiment, the system may refund the difference to the user or user account. Other reimbursement methodologies may also be considered.

In one aspect of the disclosure, there is provided a method of updating online reservations including making an original hotel reservation, monitoring price of rooms at the hotel that the original hotel reservation was made and then making a new reservation and cancelling the original reservation if a lower price for the hotel is found or a better hotel deal is found. In another aspect, the method further includes refunding the price difference back to the user or applying a credit to a user account.

In another aspect, the monitoring of the hotel prices is done from when the original hotel reservation is made until the first day of stay or a predetermined time period before the stay. In another aspect, the monitoring of the hotel prices may be based on the user's original search criteria for generating the original hotel reservation. In this manner, the new reservation may be made at another hotel. It would be understood that any new hotel reservation would preferably include all of the characteristics or benefits, such as amenities, hotel features, hotel specials of the original hotel reservation. This may not be the case if the user has applied specific criteria to the monitoring process such as, find lowest price regardless of hotel room characteristics or cancel original reservation if a room becomes available at a preferred hotel or within a preferred location.

While the system and method of the disclosure may work best where there is free cancellation of the original reservation, the cancellation fee may also be calculated into the “new” hotel price to determine if the user is receiving any actual savings after the cancellation fee is applied. However, if the user has outlined specific instructions or conditions where a cancellation should be performed, the system may create the new reservation based on the user's specific conditions.

### DESCRIPTION OF THE DRAWINGS

Embodiments of the present disclosure will now be described, by way of example only, with reference to the attached Figures.

FIG. 1 is a schematic diagram of a system for updating online reservations in an electronic commerce environment;

FIG. 2 is a schematic diagram of a processing system for use in updating reservations in an electronic commerce environment; and

FIG. 3 is a flowchart outlining a method of updating online reservations in an electronic commerce environment.

### DETAILED DESCRIPTION OF THE EMBODIMENTS

The disclosure is directed at a method and system for updating on-line reservations. In a preferred embodiment, the reservation being updated includes a free cancellation offer whereby the user is not charged a cancellation fee.

In a preferred embodiment, the disclosure is directed at a system that receives a reservation associated with a hotel room, monitors on-line offers to determine if a lower price is offered for the hotel room, cancels the hotel room reservation if lower price is found and refunds the difference in price to a user's account.

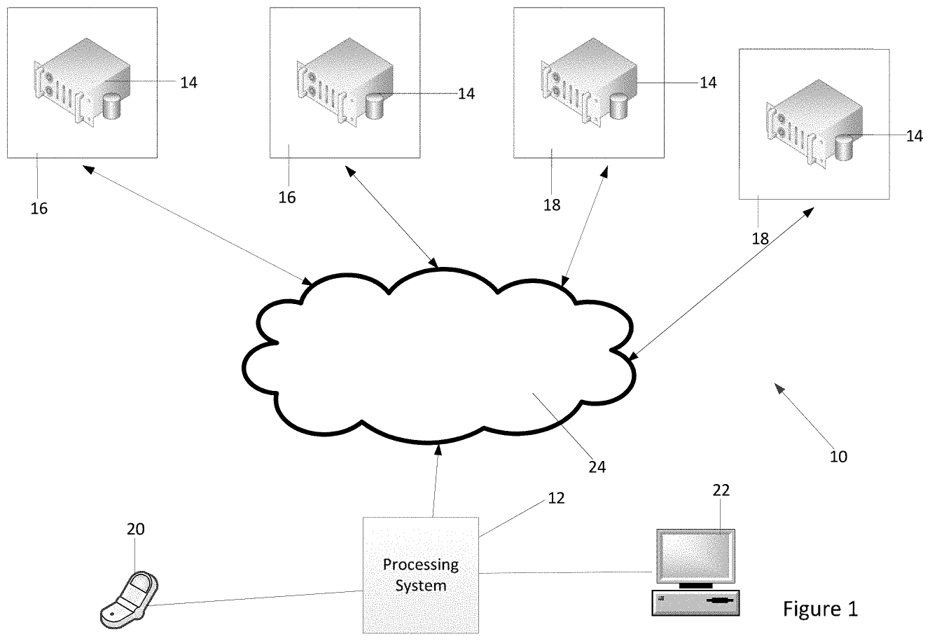

Turning to FIG. 1, a system for updating online reservations is shown. In the current embodiment, the system is used for the updating of hotel reservations, however, it will be understood that other products or services are also contemplated. In a preferred embodiment, the product or service being reserved preferably includes a free cancellation offer.

The system 10 includes a processing system (or memory component) 12 that communicates with a plurality of servers 14. Each server 14 may represent a hotel chain 16 that offers hotel rooms for reservation or a travel website 18 that allows users to search for a hotel reservation from a plurality of hotel options based on specific criteria. In one example, the hotel chain 16 may be, but not limited to, Ramada®, Hilton®, Holiday Inn® and the like while travel websites 18 may include Expedia®, Trivago® and the like. The user typically interacts with the processing system 12 via a communication device such as a Smartphone® 20, a laptop, a computer 22, a tablet and the like to create an initial hotel reservation by accessing offers displayed by the processing system 12. The offers are generated by the processing system 12 by accessing the servers 14 via a network 24 such as the Internet, to retrieve information relating to hotel room offers based on a user's search criteria.

After receiving search criteria the processing system 12 retrieves information from each of the servers 12, such as, a listing of available hotel rooms based on the search criteria. In one embodiment, the listing may include, but is not limited to, name, description, price, address, rating and/or an image relating to a product.

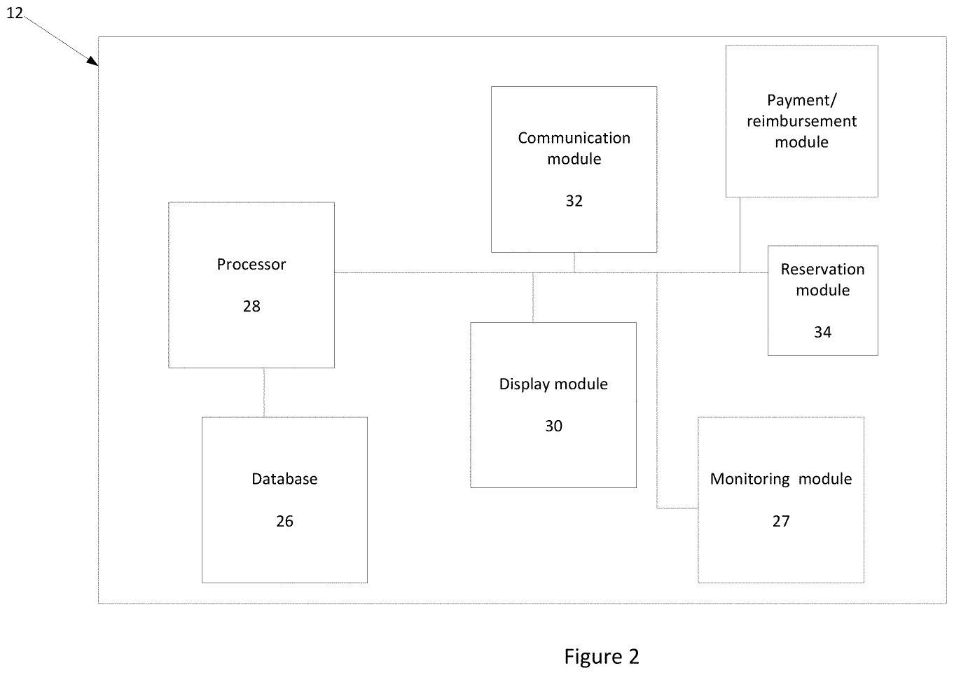

Turning to FIG. 2, a schematic diagram of the processing system 12 is shown. Within the processing system 12 are a set of modules for performing the updating of online reservations in an e-commerce environment among other functionality. It will be understood that the processing system 12 may include other components that may be necessary for the processing system to operate or function that are not described. In the preferred embodiment, the processing system 12 includes a display module 30, a communication module 32, a reservation module 34, a monitoring module 36, a payment/reimbursement module 38 and a database 40 for storing the reservations and the like.

The display module 30 is used to communicate with the communication device 20 or desktop computer 22 to display search information to the user such as the results of a search for a hotel room. In another embodiment, communication between the communication device 20 or desktop computer 22, herein both referred to by the term communication device 18, and the processing system 12 may be performed by the communication module 32 with the display module 30 providing a graphical user interface (GUI) to be displayed on the device 20. The communication module 32 may include apparatus or components to communicate with the different servers 14 to retrieve hotel availability information. As outlined above, the retrieval of the hotel room information may be performed when requested by a user via the communication device 20. The retrieval or product information may also be retrieved on a predetermined time basis such as to retrieve updated hotel room information in order to monitor hotel room prices in case there is a discount or reduction in the hotel room cost between when the user makes the reservation and the travel date. Although shown as being part of the processing system 12, the database may also be located remotely and accessed by the processing system 12, when needed.

The reservation module 34 is used to make reservations based on a user's selection. Once a user has selected a hotel listing from the list of available hotel rooms, the reservation module 34 communicates with the relevant server 12 to reserve the selected hotel room. If necessary, the reservation module 34 may also handle a cancellation of a reservation such that a new reservation may be made. This will be discussed in more detail below. After a reservation has been made or completed, the monitoring module 36 may function to monitor the price of rooms at the hotel that was reserved. If the monitoring module 36 determines that the price of the room at the hotel is lower than the original reservation price, the monitoring module 36 may communicate this to the system 12. In another embodiment, the monitoring module 36 may also monitor hotel prices at other hotels that match the user's original search criteria to determine if other hotels matching the search criteria offer a lower price before the user's travel date. In a preferred embodiment, the monitoring module confirms that when a lower price is determined, the level of amenities and other benefits associated with the original reservation are honoured.

The payment/reimbursement module 38 may function to enable a user to pre-pay for a hotel reservation or to provide a reimbursement if a lower price is determined.

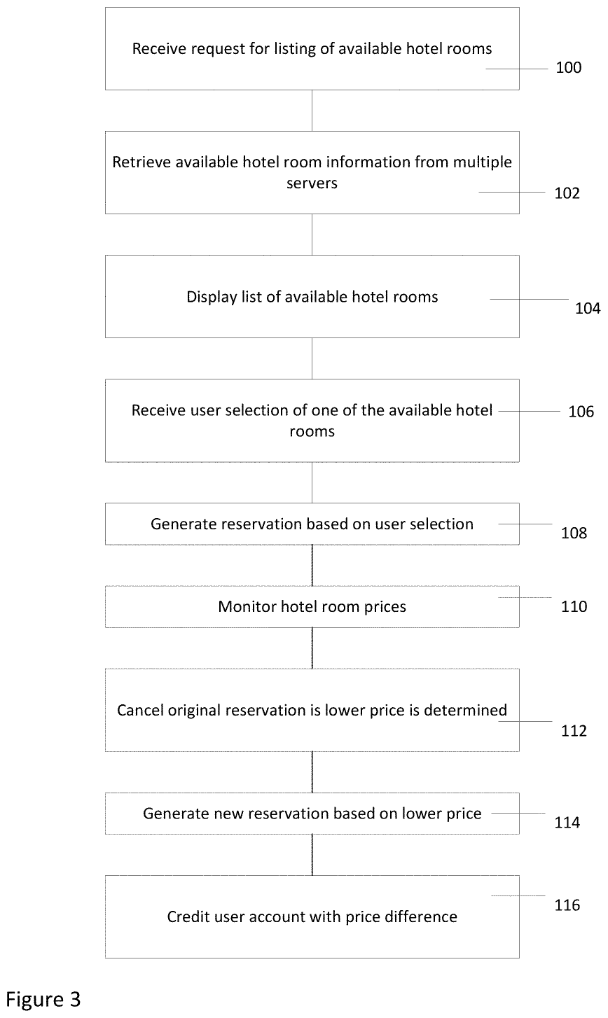

Turning to FIG. 3, a flowchart outlining a method of updating online reservations is shown. Initially, the system receives a request for a listing of available hotel rooms meeting certain search criteria from a user (100). In one embodiment, this request is received from a communication device associated with the user.

After receiving the request, the system communicates with a set of servers to retrieve information associated with available hotel rooms meeting the search criteria of the user (102). This information is transmitted to and displayed to the user (104). The user can then review the listing of available hotel rooms to select one for reservation.

The system then receives the user's selection (106) and continues to reserve the hotel room as selected by the user (108). The reservation process will be understood by one skilled in the art.

After making the reservation, the system continues to monitor the price of the hotel room that was reserved up until the travel date or the date or the reservation (110). If it is determined that the hotel room price decreases, or is lower than the original reserved price, the system cancels the original reservation (112) and makes a new reservation at the updated price (114). Depending on the set up of the system or based on predetermined user criteria, the new reservation may be automatically made or a message requesting confirmation from the user that they wish to make the new reservation may be transmitted. If the new reservation is with the same hotel as the original reservation, there may not be any need to request confirmation from the user, however if the new reservation is with another hotel (that falls within the search criteria), the system may request this confirmation.

The difference in price is then placed in a user account (116) such that the user can then use the credit for future reservations or for purchasing other available items on the system. Once the travel date passes, the system will then stop monitoring the price of the reserved hotel room.

In one embodiment, the savings may be represented by a formula:

Σᵢ₌₂ⁿ(Pᵢ−Pᵢ₋₁)−Σᵢ₌₁ⁿCᵢ

where n represents the number of times the reservation is changed before the travel deadline, n ∈ [symbol] ⁺, i ∈ [symbol] ⁺ denotes the steps the smart booking agent takes, where 0<i≤n, Pᵢ represents the prices over i steps, P ∈ [symbol] ⁺, Cᵢ represents the cancellation cost for each change, C ∈ [symbol] ⁺, and T represents a pre-defined threshold for minimum saving, T ∈ [symbol] ⁺.

The following inequality holds for sequence of P₁, 0<i≤n:

Pᵢ₊₁−Pᵢ>Cᵢ+T

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

1. (canceled)

2. A method of updating on-line reservations made by a user, the method comprising:
receiving a request for a listing of available hotel rooms;
retrieving available hotel room information from multiple servers;
displaying a list of available hotel rooms;
receiving user selection of one of the available hotel rooms;
generating an original reservation based on the user selection;
monitoring hotel room prices;
canceling the original reservation if a lower price is offered for an equivalent hotel room to the user selection; and
generating a new reservation based on the lower price.

3. The method of claim 2, further comprising crediting a user account associated with the user with a price difference between a price of the original reservation and the lower price.

4. The method of claim 2, wherein receiving the request for the listing of available hotel rooms comprises receiving search criteria defining parameters limiting a search for hotel rooms to return as the list of available hotel rooms.

5. The method of claim 4, wherein the search criteria include:
hotel name;
room description;
price; and
location.

6. The method of claim 4, wherein receiving the request for the listing of available hotel rooms comprises receiving a travel date, and
wherein monitoring hotel room prices comprises only monitoring hotel room prices for hotel rooms matching the search criteria with hotel room availability on the travel date until the travel date is reached.

7. The method of claim 6, wherein the equivalent hotel room has a same level of amenities and other benefits associated with the original reservation.

8. The method of claim 4, wherein receiving the request for the listing of available hotel rooms comprises receiving a travel date, and
wherein monitoring hotel room prices comprises only monitoring hotel room prices for a hotel at which the original reservation was made with hotel room availability on the travel date until the travel date is reached.

9. The method of claim 8, wherein the equivalent hotel room has a same level of amenities and other benefits associated with the original reservation.

10. The method of claim 2, wherein both the request for the listing of available hotel rooms and the displaying the list of available hotel rooms occur at a mobile device of the user.

11. The method of claim 2, wherein the generating the new reservation is performed automatically and without user input.

12. The method of claim 2, wherein the generating the new reservation is performed responsive to user input associated with a message generated to indicate the lower price.

13. A system for updating on-line reservations made by a user, the system comprising a reservation module comprising processing circuitry configured to:
receive a request for a listing of available hotel rooms;
retrieve available hotel room information from multiple servers;
display a list of available hotel rooms;
receive user selection of one of the available hotel rooms;
generate an original reservation based on the user selection;
monitor hotel room prices;
cancel the original reservation if a lower price is offered for an equivalent hotel room to the user selection; and
generate a new reservation based on the lower price.

14. The system of claim 13, wherein the processing circuitry is further configured to credit a user account associated with the user with a price difference between a price of the original reservation and the lower price.

15. The system of claim 13, wherein receiving the request for the listing of available hotel rooms comprises receiving search criteria defining parameters limiting a search for hotel rooms to return as the list of available hotel rooms.

16. The system of claim 15, wherein the search criteria include:
hotel name;
room description;
price; and
location.

17. The system of claim 15, wherein receiving the request for the listing of available hotel rooms comprises receiving a travel date, and
wherein monitoring hotel room prices comprises only monitoring hotel room prices for hotel rooms matching the search criteria with hotel room availability on the travel date until the travel date is reached.

18. The system of claim 17, wherein the equivalent hotel room has a same level of amenities and other benefits associated with the original reservation.

19. The system of claim 15, wherein receiving the request for the listing of available hotel rooms comprises receiving a travel date, and
wherein monitoring hotel room prices comprises only monitoring hotel room prices for a hotel at which the original reservation was made with hotel room availability on the travel date until the travel date is reached.

20. The system of claim 13, wherein both the request for the listing of available hotel rooms and the displaying the list of available hotel rooms occur at a mobile device of the user.

21. The system of claim 13, wherein the generating the new reservation is performed automatically and without user input, or
wherein the generating the new reservation is performed responsive to user input associated with a message generated to indicate the lower price.
